(19) United States
(12) Patent Application Publication
(10) Pub. No.: US 2024/0237839 A1
(43) Pub. Date: Jul. 18, 2024

(54) GRAPHENE HEATING PILLOW

(71) Applicants: Charson Technology (Suzhou) Co., Ltd., Suzhou city (CN); Creation Textiles Corp., Ltd., Suzhou City (CN)

(72) Inventor: Wenjian HE, Suzhou City (CN)

(21) Appl. No.: 18/528,442

(22) Filed: Dec. 4, 2023

(30) Foreign Application Priority Data
Jan. 15, 2023 (CN) 202310058572.4

(51) Int. Cl. A47G 9/10

(52) U.S. Cl. CPC A47G 9/1036

(57) ABSTRACT

A graphene heating pillow includes a pillow case, internally provided with a pillow inner main body; and a heating assembly, arranged on one side of an inner wall of the pillow case, where the heating assembly includes a graphene heating pad, a first connecting wire is connected to one side of the graphene heating pad, a switch is connected to one end of the first connecting wire, a second connecting wire is connected to one end of the switch, and a USB connector is connected to one end of the second connecting wire. According to the graphene heating pillow, the graphene heating pad is arranged inside the pillow case and cooperates with the first connecting wire provided with the switch and the second connecting wire provided with the USB connector, which facilitates the temperature increase and control operation on the graphene heating pad, thereby replacing the operation on a self-heating material at present.

### FIELD OF TECHNOLOGY

The present invention relates to the field of pillows, in particular to a graphene heating pillow.

### BACKGROUND

The pillow, a kind of sleep tool, is generally recognized to be a filling material used by people for comfortable sleep. From the modern medical research, the human spine is a straight line from the front, but has four physiological curves from the side. To protect the normal physiological curvature of the neck and maintain the normal physiological activities of people during sleep, a pillow should be used during sleep. The pillow generally includes two parts of a pillow inner and a pillow case.

There are many kinds of pillows at present, in which heating pillows are needed for the treatment of patients with cervical spondylosis and other diseases, but during use of existing heating pillows, a self-heating material will be used and a temperature cannot be adjusted and controlled when needed.

Therefore, it is necessary to provide a graphene heating pillow to solve the above technical problem.

### SUMMARY

The present invention provides a graphene heating pillow, which solves the problem that during use of existing treatment pillows, a self-heating material is used and a temperature cannot be controlled and adjusted.

To solve the above technical problem, the present invention provides a graphene heating pillow, including:
a pillow case, internally provided with a pillow inner main body; and
a heating assembly, arranged on one side of an inner wall of the pillow case, where the heating assembly includes a graphene heating pad, a first connecting wire is connected to one side of the graphene heating pad, a switch is connected to one end of the first connecting wire, a second connecting wire is connected to one end of the switch, and a USB connector is connected to one end of the second connecting wire.

Preferably, a material of the pillow inner main body is buckwheat and lavender.

Preferably, a communicating hole matched with the first connecting wire is provided inside the pillow case.

Preferably, a first connecting piece is arranged on one side of a surface of the pillow case, a second connecting piece is connected to one side of the first connecting piece, and a fixing ring is connected to one end of the second connecting piece.

Preferably, a storage box is arranged inside the fixing ring, and a box cover is arranged on a surface of the storage box.

Preferably, a winding assembly is arranged inside the storage box and includes two U-shaped connecting blocks, a movable block is arranged inside each of the two U-shaped connecting blocks, a circular base is connected between the two movable blocks, a winding rod is connected to a center of a surface of the circular base, and a fixing piece is arranged on a surface of the winding rod.

Preferably, through holes are symmetrically provided on two sides of the surface of the storage box.

Preferably, a protective assembly is arranged between the second connecting wire and the USB connector and includes a connecting ring, a rotating element is connected to a surface of the connecting ring, an L-shaped connecting rod is connected to one side of the rotating element, and a protective cover is connected to one end of the L-shaped connecting rod.

Compared with related technologies, the graphene heating pillow provided by the present invention has the following beneficial effects:

According to the graphene heating pillow provided by the present invention, the graphene heating pad is arranged inside the pillow case and cooperates with the first connecting wire provided with the switch and the second connecting wire provided with the USB connector, which facilitates the temperature increase and control operation on the graphene heating pad, thereby replacing the operation on a self-heating material at present.

### BRIEF DESCRIPTION OF THE DRAWINGS

FIG. 1 is a schematic structural diagram of a first embodiment of a graphene heating pillow provided by the present invention;

FIG. 2 is a schematic structural diagram of a second embodiment of a graphene heating pillow provided by the present invention;

FIG. 3 is a schematic three-dimensional structural diagram of an interior of a storage box shown in FIG. 2;

FIG. 4 is a schematic three-dimensional structural diagram of an exterior of a storage box shown in FIG. 2; and

FIG. 5 is a schematic structural diagram of a third embodiment of a graphene heating pillow provided by the present invention.

Description of reference numerals in the drawings: 1. pillow case; 2. pillow inner main body; 3. heating assembly; 31. graphene heating pad; 32. first connecting wire; 33. switch; 34. second connecting wire; 35. USB connector; 4. storage box; 5. winding assembly; 51. U-shaped connecting block; 52. movable block; 53. circular base; 54. winding rod; 55. fixing piece; 6. fixing ring; 7. second connecting piece; 8. through hole; 9. box cover; 10. first connecting piece; 11. protective assembly; 111. connecting ring; 112. rotating element; 113. L-shaped connecting rod; and 114. protective cover.

### DESCRIPTION OF THE EMBODIMENTS

The present invention is further described below with reference to the accompanying drawings and the embodiments.

### First Embodiment

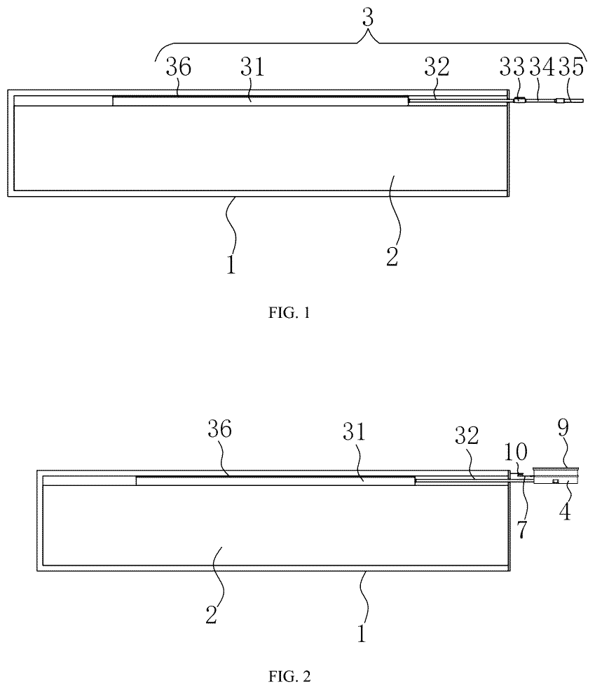

Reference is made to FIG. 1, where FIG. 1 is a schematic structural diagram of a first embodiment of a graphene heating pillow provided by the present invention. There is provided a graphene heating pillow, including:
a pillow case 1, internally provided with a pillow inner main body 2; and
a heating assembly 3, arranged on one side of an inner wall of the pillow case 1, where the heating assembly 3 includes a graphene heating pad 31, a first connecting wire 32 is connected to one side of the graphene heating pad 31, a switch 33 is connected to one end of the first connecting wire 32, a second connecting wire 34 is connected to one end of the switch 33, and a USB connector 35 is connected to one end of the second connecting wire 34.

The graphene heating pad 31 includes a heating wire and a graphene plate. The use of the switch 33 facilitates the operation of switching on or off power. The USB connector 35 facilitates the connection with an electronic device. Both the first connecting wire 32 and the second connecting wire 34 are arranged on a side of an interior of the pillow case 1.

A material of the pillow inner main body 2 is buckwheat and lavender.

A communicating hole matched with the first connecting wire 32 is provided inside the pillow case 1.

A working principle of the graphene heating pillow provided by the present invention is as follows:

During use, the USB connector 35 is connected to the electronic device, then the switch 33 is turned on, and the power is transmitted to the graphene heating pad 31 through the second connecting wire 34 and the first connecting wire 32 to perform electric heating.

Compared with related technologies, the graphene heating pillow provided by the present invention has the following beneficial effects:

According to the graphene heating pillow provided by the present invention, the graphene heating pad 31 is arranged inside the pillow case 1 and cooperates with the first connecting wire 32 provided with the switch 33 and the second connecting wire 34 provided with the USB connector 35, which facilitates the temperature increase and control operation on the graphene heating pad 31, thereby replacing the operation on a self-heating material at present.

### Second Embodiment

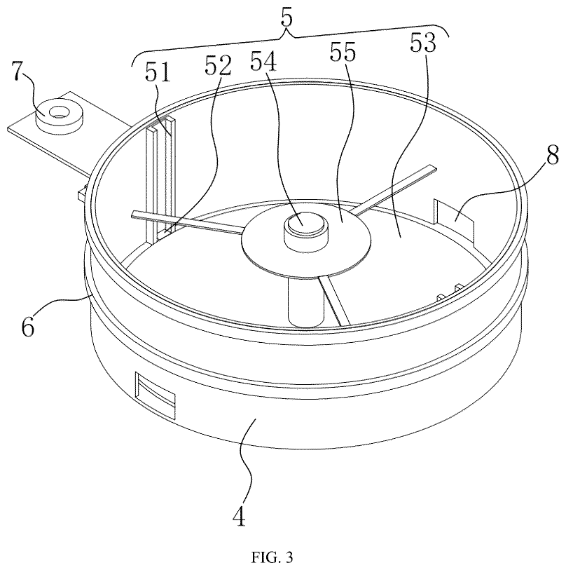

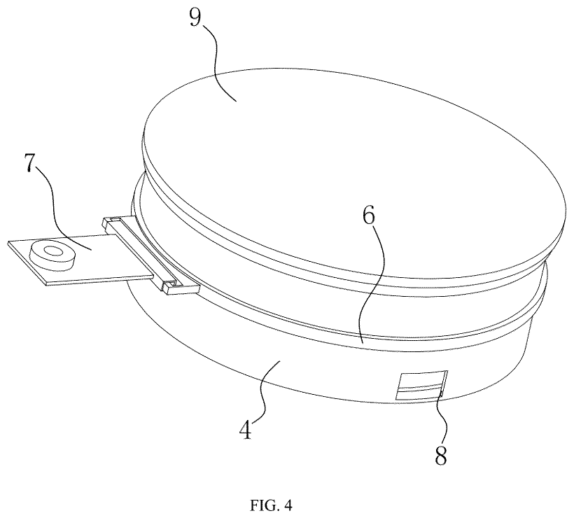

Referring to FIG. 2, FIG. 3, and FIG. 4, a second embodiment of the present application proposes another graphene heating pillow on the basis of the graphene heating pillow provided by the first embodiment of the present application. The second embodiment is only a preferred embodiment of the first embodiment, and the implementation of the second embodiment will not affect the individual implementation of the first embodiment.

Specifically, the graphene heating pillow provided by the second embodiment of the present application has a difference that in the graphene heating pillow, a first connecting piece 10 is arranged on one side of a surface of the pillow case 1, a second connecting piece 7 is connected to one side of the first connecting piece 10, and a fixing ring 6 is connected to one end of the second connecting piece 7.

Each of the first connecting piece 10 and the second connecting piece 7 includes a connecting strap and a button. The use of the first connecting piece 10 and the second connecting piece 7 facilitates the mounting and dismounting of a storage box 4.

A storage box 4 is arranged inside the fixing ring 6, and a box cover 9 is arranged on a surface of the storage box 4.

Matched threads are provided on an inner wall of the box cover 9 and on the surface of the storage box 4. The box cover 9 is connected to the storage box 4 by using the threads, which facilitates the mounting and dismounting of the box cover 9. During use, the box cover 9 is rotated to be gradually separated from the thread on the surface of the storage box 4.

A winding assembly 5 is arranged inside the storage box 4 and includes two U-shaped connecting blocks 51, a movable block 52 is arranged inside each of the two U-shaped connecting blocks 51, a circular base 53 is connected between the two movable blocks 52, a winding rod 54 is connected to a center of a surface of the circular base 53, and a fixing piece 55 is arranged on a surface of the winding rod 54.

The two U-shaped blocks 51 are symmetrically connected to two sides of an inner wall of the storage box 4. The use of the U-shaped connecting blocks 51 and the movable blocks 52 facilitates the positioning of the circular base 53 during mounting. Matched threads are provided on the surface of the winding rod 54 and inside the fixing piece 55. The use of the winding rod 54 facilitates the winding of the first connecting wire 32 and the second connecting wire 34. The use of the fixing piece 55 can play a role in fixing the first connecting wire 32 and the second connecting wire 34.

Through holes 8 are symmetrically provided on two sides of the surface of the storage box 4.

The providing of the through holes 8 facilitates the placement and use of the first connecting wire 32 and the second connecting wire 34.

A working principle of the graphene heating pillow provided by the present invention is as follows:

During use, when the first connecting wire 32 and the second connecting wire 34 are wound, firstly the circular base 53 provided with the winding rod 54 and the movable blocks 52 is pulled to move up inside the two U-shaped connecting blocks 51; after the winding rod 54 is pulled to an outer side of the storage box 4, the first connecting wire 32 and the second connecting wire 34 are wound on the surface of the winding rod 54; and after the first connecting wire 32 and the second connecting wire 34 are wound well, the fixing piece 55 is in thread connection with the winding rod 54.

Compared with related technologies, the graphene heating pillow provided by the present invention has the following beneficial effects:

In the graphene heating pillow provided by the present invention, the storage box 4 provided with the winding assembly 5 is arranged on one side of the surface of the pillow case 1, which facilitates the storage of the first connecting wire 32 and the second connecting wire 34 when not in use, thereby preventing the first connecting wire 32 and the second connecting wire 34 from being stacked and wound.

### Third Embodiment

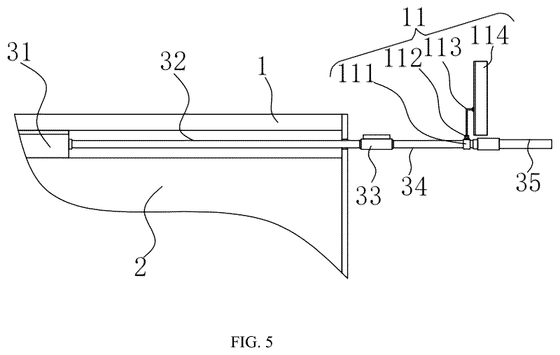

Referring to FIG. 5, a third embodiment of the present application proposes another graphene heating pillow on the basis of the graphene heating pillow provided by the first embodiment of the present application. The third embodiment is only a preferred embodiment of the first embodiment, and the implementation of the third embodiment will not affect the individual implementation of the first embodiment.

Specifically, the graphene heating pillow provided by the third embodiment of the present application has a difference that in the graphene heating pillow, a protective assembly 11 is arranged between the second connecting wire 34 and the USB connector 35 and includes a connecting ring 111, a rotating element 112 is connected to a surface of the connecting ring 111, an L-shaped connecting rod 113 is connected to one side of the rotating element 112, and a protective cover 114 is connected to one end of the L-shaped connecting rod 113.

The connecting ring 111 is fixedly connected to a surface of the second connecting wire 34. The use of the rotating element 112 and the L-shaped connecting rod 113 facilitates the rotatable connection of the protective cover 114.

A working principle of the graphene heating pillow provided by the present invention is as follows:

During use, when the USB connector 35 is not in use, the protective cover 114 is sleeved on a surface of the USB connector 35 by the rotating element 112 and the L-shaped connecting rod 113.

Compared with related technologies, the graphene heating pillow provided by the present invention has the following beneficial effects:

In the graphene heating pillow provided by the present invention, the connecting ring 111 provided with the rotating element 112 and the L-shaped connecting rod 113 is arranged on the surface of the second connecting wire 34 and is used in cooperation with the protective cover 114, which facilitates the protection of the USB connector 35.

The above are only the embodiments of the present invention, rather than limiting the scope of patent of the present invention. Any equivalent structures or equivalent process transformations made using the content of the specification and the accompanying drawings of the present invention, directly or indirectly applied in other related technical fields, are similarly included in the scope of patent protection of the present invention.

What is claimed is:

1. A graphene heating pillow, comprising:
a pillow case, internally provided with a pillow inner main body; and
a heating assembly, arranged on one side of an inner wall of the pillow case, wherein the heating assembly comprises a graphene heating pad, a first connecting wire is connected to one side of the graphene heating pad, a switch is connected to one end of the first connecting wire, a second connecting wire is connected to one end of the switch, and a USB connector is connected to one end of the second connecting wire.

2. The graphene heating pillow according to claim 1, wherein a material of the pillow inner main body is buckwheat and lavender.

3. The graphene heating pillow according to claim 1, wherein a communicating hole matched with the first connecting wire is provided inside the pillow case.

4. The graphene heating pillow according to claim 1, wherein a first connecting piece is arranged on one side of a surface of the pillow case, a second connecting piece is connected to one side of the first connecting piece, and a fixing ring is connected to one end of the second connecting piece.

5. The graphene heating pillow according to claim 4, wherein a storage box is arranged inside the fixing ring, and a box cover is arranged on a surface of the storage box.

6. The graphene heating pillow according to claim 5, wherein a winding assembly is arranged inside the storage box and comprises two U-shaped connecting blocks, a movable block is arranged inside each of the two U-shaped connecting blocks, a circular base is connected between the two movable blocks, a winding rod is connected to a center of a surface of the circular base, and a fixing piece is arranged on a surface of the winding rod.

7. The graphene heating pillow according to claim 5, wherein through holes are symmetrically provided on two sides of the surface of the storage box.

8. The graphene heating pillow according to claim 1, wherein a protective assembly is arranged between the second connecting wire and the USB connector and comprises a connecting ring, a rotating element is connected to a surface of the connecting ring, an L-shaped connecting rod is connected to one side of the rotating element, and a protective cover is connected to one end of the L-shaped connecting rod.
